(19) United States
(12) Patent Application Publication
(10) Pub. No.: US 2010/0057286 A1
(43) Pub. Date: Mar. 4, 2010

(54) Solar crawling lawn mower

(76) Inventor: Robert Kerchner, Valencia, CA (US)

Correspondence Address: Robert Kerchner, 23315 Clifton Place, Valencia, CA, 91354, US

(21) Appl. No.: 12/198,656

(22) Filed: Aug. 26, 2008

(51) Int. Cl. G05D 1/00

(52) U.S. Cl. 701/25

(57) ABSTRACT

The device concerns an ultra lightweight, solar powered, self-propelled, programmable, low-speed crawling lawn mower, and an operating method for use of such invention. The unit consists of a cover housing/solar cell deck with watertight compartment(s) for circuitry; sitting atop an open slow-cutting head, with a pair of spoke wheels at either side. The front spoke wheels function as drive wheels, followed by freely turning back reference wheels equipped with incremental rotary encoders to measure their relative turn rates. The two drive wheels are connected to two variable speed drive motors and gearboxes (disconnectable during programming), which are in turn powered individually and independently by a processor. Such processor follows a memory pattern, matching this against real-time reference wheel data to determine relative power levels appropriate for the two front drive wheels. Intermittent stationary reference points may be derived by a sensor plate on the rear of the device.

### BACKGROUND OF INVENTION

The device is an improvement over traditional methods of lawn mowing which are high-powered, and not self sufficient. These methods require human attendance as well as power inputs that vary from physical exertion, to gasoline, to high voltage electricity (via electric cord or a separately charged battery). The device, on the other hand, allows unattended mowing, on a daily basis, so that the lawn never appears “unmowed”, and it uses the same power supply as the grass itself—the sun—in order to keep the lawn appearance tidy. Thus, it accomplishes the same task at no energy cost whatsoever. What's more, it accomplishes the task at a slow pace, with steady progress, and a lightweight carriage that comprise a far safer method than any traditional means of lawn mowing.

The device is likewise an improvement over robotic lawnmowers, which are far heavier, require external power sources, are more expensive to produce, and/or rely on grass sensors, random movement, complicated algorithms, and/or buried cables for guidance. Like traditional lawnmowers, these robotic forms also use high speed blades and rapid movement, and are therefore potentially even more dangerous in robotic applications than they are with human-attended use. In contrast, this slow, steady, and secure solar device solves all of these drawbacks, and does so at a much reduced cost—both originally and operationally.

### BRIEF SUMMARY OF INVENTION

The invention is a user-programmable, self-propelled, solar powered, slow-moving robotic lawnmower which uses nontraditional means for cutting and robotic movement.

### BRIEF DESCRIPTION OF THE SEVERAL VIEWS

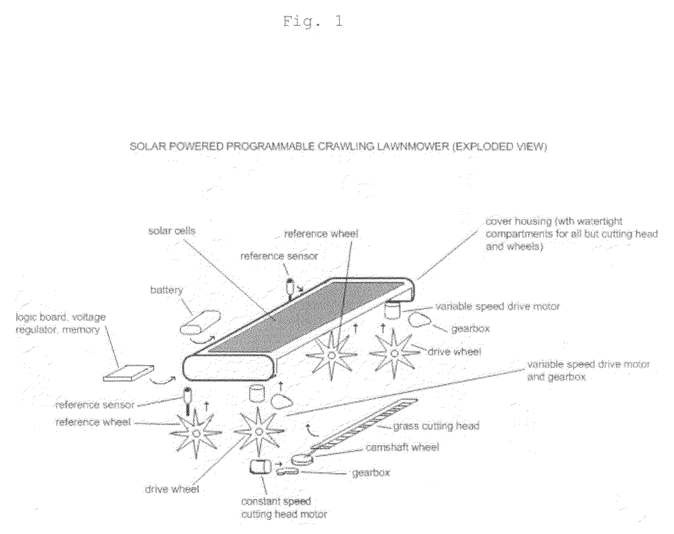

FIG. 1—Exploded view of the device

This view shows the components of the device, including its solar-cell covered housing with watertight compartments, battery, two variable speed drive motors and one constant speed cutting motor, cutting head, gearboxes, wheels, and wheel reference sensors.

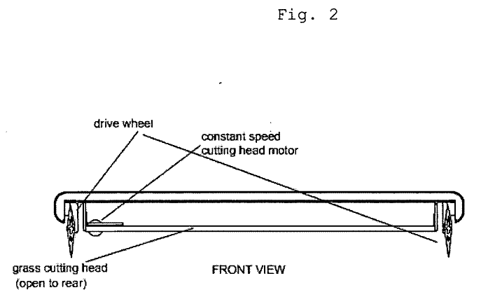

FIG. 2—Front view of the device

This view shows the device as seen from the front in normal view, including its drive wheels, adjustable-height grass cutting head, and motor.

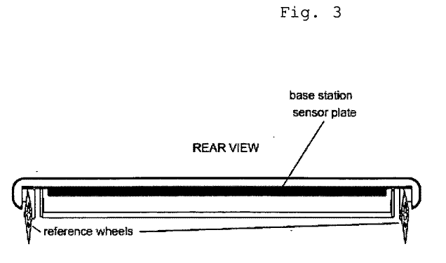

FIG. 3—Rear view of the device

This view shows the device as seen from the rear in normal view, including reference wheels and base sensor plate.

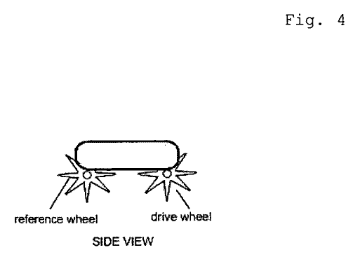

FIG. 4—Side view of the device

This view shows the device as seen from the side in normal view, including forward drive wheels and rear reference wheels.

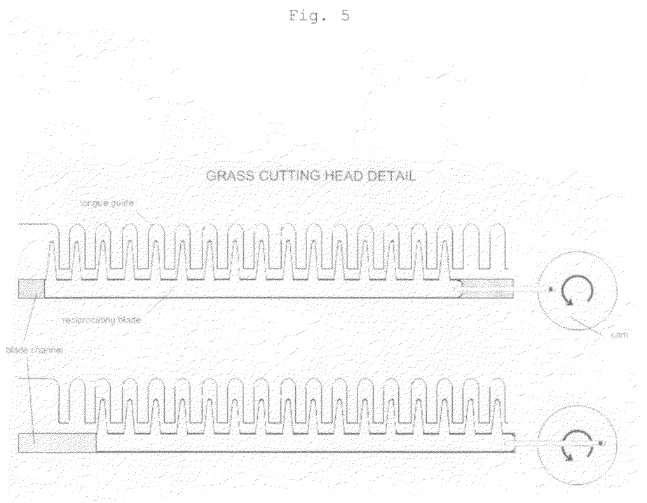

FIG. 5—Cutting head detail

This view shows the grass cutting head detail, in which the narrow toothed guides funnel the blades of grass into position for the blades to cut, as cam action causes the blade to reciprocate.

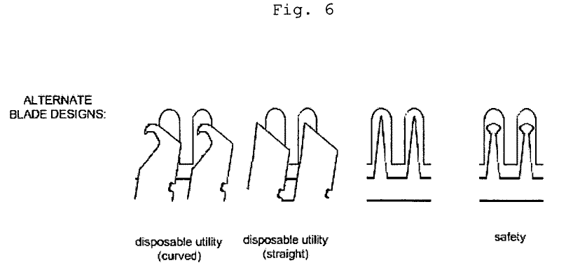

FIG. 6—Blade assembly options

This view shows the assembly options for the blades, including safety cutting, and disposable utility knife inserts (both curved and straight).

### DETAILED DESCRIPTION OF INVENTION

The device concerns an ultra lightweight, solar powered, self-propelled, programmable, low-speed crawling lawn mower, and an operating method for use of such invention. The unit consists of a cover housing/solar cell deck with watertight compartment(s) for circuitry; sitting atop an open slow-cutting head, with a pair of spoke wheels at either side. The front spoke wheels function as drive wheels, followed by freely turning back reference wheels equipped with incremental rotary encoders to measure their relative turn rates. The two drive wheels are connected to two variable speed drive motors and gearboxes (disconnectable during programming), which are in turn powered individually and independently by a processor. Such processor follows a memory pattern, matching this against real-time reference wheel data to determine relative power levels appropriate for the two front drive wheels. The memory pattern is initially created by recording the relative rotation speeds of the back reference wheels when the user first moves the device around the lawn during the programming phase. A third motor drives a constant speed reciprocal cutting head with a narrow safety tongue guide, adjustable by the user for height. All three motors are highly torqued/slow speed to minimize energy usage while supplying the necessary force for movement and cutting. Power for the device is provided by photovoltaic cells on the cover housing/solar cell deck, feeding a battery, which supplies power to the processor and motors. Intermittent stationary reference points (and optional supplemental low voltage battery recharge) may be derived by a sensor plate on the rear of the device, which is contacted by two leads at a user-determined base station, with course-correction and reestablished guidance based on the relative position of the leads' contact points on the sensor plate.

What is claimed is:

1. An operating method for a slow-speed, solar powered programmable lawn mower which comprises:
precharging the battery using solar energy,
positioning the mower at a user-determined reference point, engaging program recording, and moving the mower around the lawn as desired so that the unit records the specific relative turn rates for the reference wheels over exact incremental distances, with the user ultimately returning to the original reference point and terminating the recording,
executing the recorded program in an indefinite loop, such that the processor powers the two variable drive motors in order to produce an identical relative turn rate over exact incremental distances in and between the two trailing reference wheels,
using lightweight materials, solar cell power, and minimal electric current,
powering the variable motors, the processor, regulator(s), and constant speed motor for the reciprocating cutting head, which moves slowly but inexorably against a grass-blade tongue guide to cut grass in a safer manner than traditional highpowered mower designs,
intermittently self-checking against the stationary reference point by means of at least two wire leads at that point, making connection with contact points on a sensor plate, and thereafter reorienting to achieve the original orientation, then continuing program loop,
powering down to preserve memory and processing function overnight or in long shady conditions as needed,
optionally recharging battery at the stationary reference point for shady/nighttime use by means of low voltage input

2. Robotic mowing device as described in Abstract, comprising an ultralight, slow moving, low profile, photovoltaic powered crawler with on-board solar collection, battery, memory, incremental reference wheels, drive wheels, reciprocating blade, original orientation sensor bar, and computer processing in order to apply the process of claim 1

3. Device according to claim 2 characterized in that it comprises a self-propelled, low-speed lawnmower with spoke-only wheel design for greater traction on each driving wheel and accurate reference using incremental rotary encoders as reference sensors on each reference wheel.

4. Device according to claim 2 characterized in that it incorporates at least two independently and variably powered drive wheels for program execution, with drive motor linkages that may be disconnected during programming to allow easy maneuvering.

5. Device according to claim 2 characterized in its use of a slow-speed reciprocal cutting head with pointed tongue guides to channel grass blades into narrow slots for cutting (while preventing injury to other objects or animals), variable in overall height off the ground as desired by user.

6. Device according to claim 2 designed for the minimal energy availabilities of photovoltaic cells, including motors with low draw, and high torque/slow speed gearing.

7. Device according to the methodology of claim 1 with a sensor plate and reorientation program, wherein the sensor completes a circuit derived from at least two wires protruding from the original stationary reference point, and unit then reorients to achieve its original orientation, as necessary.

8. Alternate reciprocating blade design according to claim 5, including blunted safety blade, multiple disposable snap-in curved utility blades, and multiple disposable snap-in straight utility blades as shown in attached drawings
